(19) United States
(12) Patent Application Publication
(10) Pub. No.: US 2010/0220187 A1
(43) Pub. Date: Sep. 2, 2010

(54) OPTICAL MEASUREMENT OF FILL LEVEL

(75) Inventors: Christina LICHTBLAU, Biberach (DE); Stefan BASSARAB, Biberach (DE); Karoline BECHTOLD-PETERS, Biberach (DE); Christian BRADER, Memmingen (DE)

Correspondence Address: MICHAEL P. MORRIS;BOEHRINGER INGELHEIM USA CORPORATION, 900 RIDGEBURY ROAD, RIDGEFIELD, CT, 06877-0368, US

(73) Assignee: BOEHRINGER INGELHEIM PHARMA GMBH & CO. KG, Ingelheim (DE)

(21) Appl. No.: 12/630,923

(22) Filed: Dec. 4, 2009

(30) Foreign Application Priority Data
Dec. 6, 2008 (DE) 102008060960.9

(51) Int. Cl. H04N 7/18; B65B 3/30

(52) U.S. Cl. 348/135; 53/503; 348/E07.085

(57) ABSTRACT

The invention relates to the optical measurement of fill level in the aseptic bottling or packaging of biopharmaceuticals. The process according to the invention allows in particular in-process fill level measurement of primary packaging means filled with protein solution with small volumes and with considerable variations in the packaging means. The invention also relates to an apparatus according to FIG. 5B.

### BACKGROUND TO THE INVENTION

1. Technical Field

The invention relates to the field of the optical measurement of fill level in the aseptic bottling or packaging of biopharmaceuticals. The process according to the invention allows in particular in-process measurement of the fill level of primary packages filled with protein solution with small volumes and with considerable variations in the packaging means. The invention also relates to an apparatus according to FIG. 5B.

2. Background

The current standard in pharmaceutical technology and with the manufacturers of packaging plants for in-process fill level measurement is differential weighing, i.e. the container or vial to be filled is first weighed empty, then filled and weighed again. This gives the fill weight and, by means of the density of the liquid, the fill volume.

In order to detect fluctuations/variations in the fill level early during the ongoing process, monitoring should be carried out on as many vials as possible, e.g. every fifth vial. With an average machine throughput of e.g. 2000 vials/h, this would require a number of high-precision weighing cells, which are very expensive. Moreover, these weighing cells are fixedly installed in a filling line or plant. In the field of Clinical Supplies & Process Transfer of G Pharma Development clinical samples and products are prepared for study and development purposes. Unlike in production areas, constantly changing products and packaging formats are handled on different filling apparatus. It is impossible or prohibitively expensive to equip existing or older filling apparatus with weighing cells.

Up till now, manual differential weighing has been carried out every 15 min in the Clinical Supplies & Process Transfer area. For this, an empty vial is removed from the process by an employee, weighed, labelled and re-inserted in the filling plant. After filling, the vial is weighed again. Because the vial has been removed from the ongoing process it then has to be thrown away. Apart from the resulting waste, this method has two disadvantages. First, manual interventions by employees during aseptic filling should be avoided wherever possible and secondly, because of the time spent on differential weighing only a tiny fraction of the vials can be monitored to check whether they contain the correct fill quantity.

### SUMMARY OF THE INVENTION

Measurement of the fill level using a camera and direct calculation of the resulting fill volume by the controller provide an alternative to weighing cells. In this contactless in-process monitoring, the vials do not have to be removed from the process. The machine throughput is not affected by this additional measurement. If a vial is detected with a fill level outside the prescribed tolerance, this may be indicated by a visual or audible signal. It is also possible to link the camera system to the computer-programmable control of the filling machine so that the machine is stopped if over- or underfilling is occurring.

When implementing the optical measurement of fill level for biopharmaceutical filling, the following technical problems or constraints arise:
existing packaging tolerances in the dimensions (e.g. for 2R vials, overall height +/−0.5 mm, outer diameter +/−0.15 mm, base convexity . . . , cf. on this subject FIGS. 2B and C),
movement of the liquid in fast-rotating machines,
vibration and sloshing,
foaming as a result of protein content,
special requirements when carrying out aseptic filling, such as avoiding manual intervention,
small scale (generally 0.5 ml to 50 ml).

The problem thus arises of providing a method of optically measuring fill level in the aseptic bottling or packaging of biopharmaceuticals which gives precise and reproducible measurements (particularly in-line measurements) in spite of existing packaging tolerances with small volumes, movement of the liquid, sloshing and foaming.

A further aim is to provide a corresponding apparatus for optical measurement of the fill level.

The present invention solves the problem by providing a process for the optical measurement of fill level during the aseptic bottling or packaging of biopharmaceuticals, comprising the following steps:
a. transporting a transparent primary packaging means (4) filled with a protein solution, the fill volume being less than or equal to 100 ml,
b. moving the filled primary packaging means (4) past a camera (1a) with lighting,
c. controlling the image capture using an external trigger (3) that is linked to the camera (1a) via a controller (5),
d. delivering the measurement through the controller (5),
e. displaying it on a monitor (7) or on a linked PC (6a);
   the primary packaging means (4) being separate and suspended at the time of measurement.

The measured value is displayed directly on a monitor or on a linked PC. This process is particularly suitable for the in-process measurement of fill level.

Essential aspects of this process are:
primary packaging means/vials must be suspended, and must hang as straight as possible,
primary packaging means/vials must be separated
the material of the primary packaging means/container/vial must be transparent, e.g. made of glass or transparent plastics.

Separation and suspension are important for precisely measuring each individual vial and bases of vials or the lower edge of carpules, for example. As a result of the separation there is additionally the possibility of measuring the outer diameter of the vial or carpule if necessary. Accordingly, in a preferred embodiment, the separation and suspension are particularly important for precisely measuring the outer diameter and base convexity of vials or the lower edge of carpules, for example.

Thus in the optical measurement of fill level the substantial fluctuations in packaging means (cf. FIGS. 2B and C) are also measured and then excluded from the calculation or compensated. The substantial fluctuations in packaging means, particularly in the base convexity of vials commonly used for packaging biopharmaceuticals, such as e.g. 20R and 2R vials, which are made of tubing glass, are a result of the manufacturing methods as the base is moulded automatically.

In conventional packaging or bottling, the primary packaging means are advanced passively in an upright position. During this process the primary packaging means are in contact with one another and the outer diameter and the base or base convexity cannot be detected or measured exactly.

For calculating the actual fill volume from the fill level measured, the following geometric dimensions of a vial are crucial (see FIG. 2C):
outer diameter d₁
wall thickness s₁
shaping of the base of the vial due to
   base thickness s₂
   base convexity t
   radius r₂

As the outer diameter d₁ is subject to relatively large tolerances of almost ±10%, it should also be measured, in order to obtain exact results with the fill volume. In a preferred embodiment d₁ must be measured as well for exact results with the fill volume. To do this it is essential that the glass objects do not touch one another in the measuring area but are separated. The published value according to FIG. 2C is used for the wall thickness s₁. If the outer diameter d₁ is not measured, the published value is used for d₁ according to FIG. 2C, as for the wall thickness s₁.

As the dimensions of the vial base s₂, t, r₂ have only minimum or maximum tolerances on account of the manufacturing process and therefore the shape of the base may be subject to large fluctuations overall, it is advisable for the measurement of the vial base to be included in the calculations of the fill volume. In a preferred embodiment, a measurement of the vial base must be included in the calculations of the fill volume.

For better image capture of the base region and better measurability, it is essential that the vials are not standing and in contact with the standing rail but are suspended.

Additionally, for precise measurement of the fill volume, it is important to achieve the correct setting and the correct distance between the camera lens and the background lighting.

For calculating the fill volume in the case of vials or injection bottles the following formula is preferably used:

[(MV fill level−base thickness*0.9)*π*(MV outer diameter−2*wall thickness s₁)²/4)]/100

The factor 0.9 is an empirically determined value which takes account of the base convexity of the 2R vial. For each primary packaging means a specific empirically determined factor is obtained.

In addition the following formula is used if the outer diameter and base convexity are not included in the measurements:

[(MV fill level−base thickness)*π*(outer diameter d₁−2*wall thickness s₁)²/4)]/1000

A constant factor is assumed here for the base thickness, e.g. 1.8 mm for 20R vials, which is determined empirically for each size of vial.

The values known from the literature as shown in FIG. 2C are used for the outer diameter d₁ and the wall thickness s₁.

For carpules and ready-to-use syringes a slightly modified formula is obtained for calculating the fill volume. In the case of carpules, the stopper is preferably used as the reference point for the lower edge while in ready-to-use syringes the shoulder of the syringe is the reference point, for example.

FIG. 9 shows as an example the measurement of the fill volume in the front chamber of a twin-chamber carpule. The formula for this is preferably as follows:

[MV fill level C*π*(outer diameter B−2*wall thickness D)²/4)]/1000+X

For the outer diameter B either the camera measurement or the measurements on the technical drawings may be used. The wall thickness D is taken from the technical drawings. X describes a constant millilitre value which theoretically corresponds to the volume in the bypass and is added to each measurement.

The present invention also encompasses an apparatus according to FIG. 5B, which contains a star wheel (8) for separating the primary packaging means. The apparatus according to the invention consists of a camera system (1a), a device for separating the primary packaging means (4) and a device for suspending (9) the primary packaging means. The apparatus according to the invention is an apparatus for optically measuring fill level. The separation is preferably carried out by means of a star wheel. The star wheel has advantages over passive conveying as contactless separation takes place.

The star wheel is simpler than an electric barrier or a conveyor belt as it does not require any separate control.

The suspension device is essential for the accuracy of measurement that can be achieved with the apparatus. In the drinks industry, primary packaging means such as bottles are generally measured in an upright position on conveyor belts as the requirements for accuracy of filling are not as stringent as in the packaging of biopharmaceuticals.

The primary packaging means/vials are guided in the neck region by means of two rails from which the vials are suspended by their rolled edge (cf. FIGS. 5A+B). The standing rail is lowered downwards for example in the region of the camera shot (between the dotted lines in FIG. 5B) to allow clear delineation of the base of the vials.

The optical measurement of fill level according to the present invention is a contactless, non-destructive, non-remote, non-stop method of measuring the fill level, preferably in-process measurement of fill level, in transparent containers (vials/injection bottles/ready-to-use syringes/carpules).

Compared with manual and automatic differential weighing, the process according to the invention is faster. This leads to a higher number of containers monitored without having to reduce the speed of the machine. A comparably high monitoring frequency without reducing the speed of the machine would not be possible using differential weighing, or could only be achieved by using a plurality of weighing cells. In addition, manual differential weighing is only possible on random samples. The vial has to be destroyed after the differential measurement (as it has been removed by hand). By contrast, the optical measurement of fill level according to the present invention is non-destructive.

With the present invention it is possible to achieve an outstanding reproducible accuracy of over 90%. Cf. on this point Example 2, page 17 onwards, described under 2R vials on B&S No. 4, guiding of the vials on a standing rail, test arrangement (1), in which the proportion of satisfactory measurements is 93.6%. Preferably the reproducible accuracy and hence the satisfactory measurements are over 95%, particularly preferably over 99.9%. With the present invention an outstanding reproducible accuracy of +/−2% of the actual fill quantity at fill volumes >=1.0 ml can be achieved in over 95% of measurements or an accuracy of +/−3% can be achieved in over 99%. For fill volumes <1.0 ml a reproducible accuracy of +/−5%—preferably +/−3%—of the actual fill quantity is achieved in over 95% of the measurements. Cf. on this point Example 3, described on page 24 onwards.

The term “defective measurements” refers to all the measured results in which it is not possible to calculate the fill volume correctly. Possible causes of these defective measurements are the use of the wrong edges in the geometric measurement of the camera image or the fact that the reference edges needed have not been found by the programme at all. If the primary packaging means that are to be measured are in contact with other primary packaging means on one side, for example, the camera programme does not find a reference edge, or finds the wrong reference edge, for locating the measuring window or for measuring the outer diameter.

Further advantages of the process according to the invention are:
it is cheaper than weighing cells
it takes up less room than weighing cells
a camera system may theoretically be used in every bottling plant, or may be applied to different plants, or may be fitted on generally as an added extra.

The process according to the invention can be used in:
measuring the fill level in the aseptic bottling of liquids, e.g. biopharmaceuticals, in vials, ready-to-use syringes, carpules, ampoules . . . .
detecting the position of the stopper in ready-to-use syringes or carpules.

As the end or middle stopper is put into position in carpules and twin-chamber carpules before they are filled with protein solution, the weight of the stopper has to be taken into consideration during the differential weighing. For manual differential weighing, this would mean that the carpule to be weighed would have to be removed from the process after the stopper has been fitted and before the filling for the gross weighing. Similarly, reintroduction into the process would also have to take place at a point after the insertion of the stopper. With the compact design of the filling plants that are used in development this procedure is generally impossible to carry out in practice.

The optical measurement of fill level as used in the drinks industry, for example, does not solve the problem of the present invention, as

a) filling does not have to take place under aseptic conditions comparable to those in the pharmaceutical industry (meaning that no related problems arise, manual removal is possible, there are no GMP regulations . . . ) and
b) the small scale in pharmaceutical bottling and in the present invention requires a significantly higher accuracy of measurement. The fill volume in particular is less than or equal to 100 ml, preferably less than or equal to 75 ml, less than or equal to 50 ml, less than or equal to 25 ml, particularly preferably less than or equal to 20 ml. The fill volume is in particular in the range from 100 ml to 0.5 ml, 50 ml to 0.5 ml, preferably in the range from 25 ml to 2 ml or 20 ml to 1 ml and particularly preferably in the range from 2 ml to 0.5 ml.

The effect of the foaming that often occurs when protein solutions are bottled makes it considerably more difficult to measure fill level optically. This is an additional technical constraint when optically measuring the fill level of protein solutions, particularly antibody solutions (cf. e.g. Example 3 BI-Mab 1000b). Thanks to the use of the process or apparatus according to the invention, the fill volumes measured are, however, within narrow tolerances, in spite of foaming, and have excellent reproducible accuracy (see above). The measurements obtained in the test series carried out with protein solution even show comparable results to the measurements obtained in the test series carried out with water.

Experimentally, it has also been found that the greater the fill volume, the smaller the percentage deviations of the measured values from the actual fill volume. This means that, with the small fill volumes used in biopharmaceutical bottling, a precise optical measurement of fill level is a considerably greater technical constraint than in the case of large fill volumes as found in the drinks industry, for example.

### DESCRIPTION OF THE FIGURES

In the Figures described below, the following abbreviations or shortened forms are used throughout:
1a: camera
1b: lens
2a: background lighting
2b: control of background lighting
3: external trigger
4: filled primary packaging means, e.g. vial
5: controller
6a: PC/laptop
6b: control console
7: monitor
8: star wheel
9: guide rail
10a: standing rail
10b: standing rail, lowered section
A: rectangularity tolerance
B: outer diameter
C: fill level
D: shutter height (constant value)
E: wall thickness (literature value)
X: detail

FIG. 1: Measuring Principle

Schematic representation of the operating principle of the optical measurement of fill level using a camera system.

FIG. 2: Preliminary Tests

A: Schematic representation of the measuring principle of the preliminary tests

B: Injection bottles made of tubing glass (according to EN ISO 8362-1:2004) with an enlarged detail X of the neck region; A=rectangularity tolerance, R=radius

C: Details of dimensions of the injection bottles in millimetres; in particular the tolerances in d₁ and in the shaping of the base of the vial demonstrate major fluctuations, whereas those in s₁ are negligible.

FIG. 3: Guiding of Vials on a Standing Rail

Schematic Representations:

A: Separation of vials by means of a star wheel

B: Guiding of vial and positioning of the camera and background lighting

FIG. 4: Box-Plot of Tests (1) to (4)

Graphic representation for comparing accuracy of measurement.

The Y-axis corresponds to the fill volume in millilitres. The 4 series of measurements on the X-axis correspond to the test arrangements as described in Example 2 from page 16 onwards under 2R vials on B&S No. 4, guiding of the vials on standing rail.

FIG. 5: Guiding of Suspended Vials

A: Schematic representation of the guidance of the suspended vials

B: Schematic representation of apparatus for separating vials when suspended

The vials are guided in the neck region by two guide rails (9) by which the vials are suspended by their rolled edge. The standing rail is lowered downwards in the region of the camera shot (10b) (between the dotted lines), to allow the base of the vial to be clearly delineated/represented.

FIG. 6: Test Series with Vials Measured while Suspended

A: Table providing a summary of the test principle and design and the statistical results.

B: Graphic representation of the results from 6A

The Y-axis corresponds to the fill volume in millilitres.

1) Fill level measured centrally with 4 segments; measurement of the outer diameter with 4 segments=89.1% satisfactory measurements,

2) Fill level measured centrally with 4 segments; measurement of the outer diameter with 4 segments; trigger delay reduced=86.4% satisfactory measurements,

3) Fill level measured laterally with 2 segments; measurement of the outer diameter with a wide segment; measurement of the base thickness in one region=93.6% satisfactory measurements.

Test arrangement 3 is preferred. This gives the highest proportion of satisfactory measurements.

FIG. 7: Schematic Representation of Example 3

The camera programmes were adjusted to increase the precision inter alia by moving the measuring window in the x- and y-directions and by compensating the angle along the y-axis for diagonally suspended vials.

FIG. 8: Graphic and Tabulated Representation of the Measurements Obtained with the Test Series from Example 3

A: 10R, water (090909_{—}01) and 10R, BI-Mab 1000b, 5 mg/ml (100909_{—}01)

B: 20R, BI-Mab 1000b, 5 mg/ml (100909_{—}02)

C: 2R, BI-Mab 1000b, 20 mg/ml (190109_{—}01) and 2R, water (190109_{—}02)

FIG. 9: Schematic Representation of Determination of Fill Volume of Twin-Chamber Carpules

B outer diameter, C fill level, D wall thickness, 11 twin chamber carpule, 12 rubber stopper, 13 bypass

### DETAILED DESCRIPTION OF THE INVENTION

The terms and designations used within the scope of this description have the meanings defined as shown below. The general terms “containing” or “contains” also encompass the more specific term “consisting of”. In addition, the terms “singularity” and “plurality” are not used restrictively.

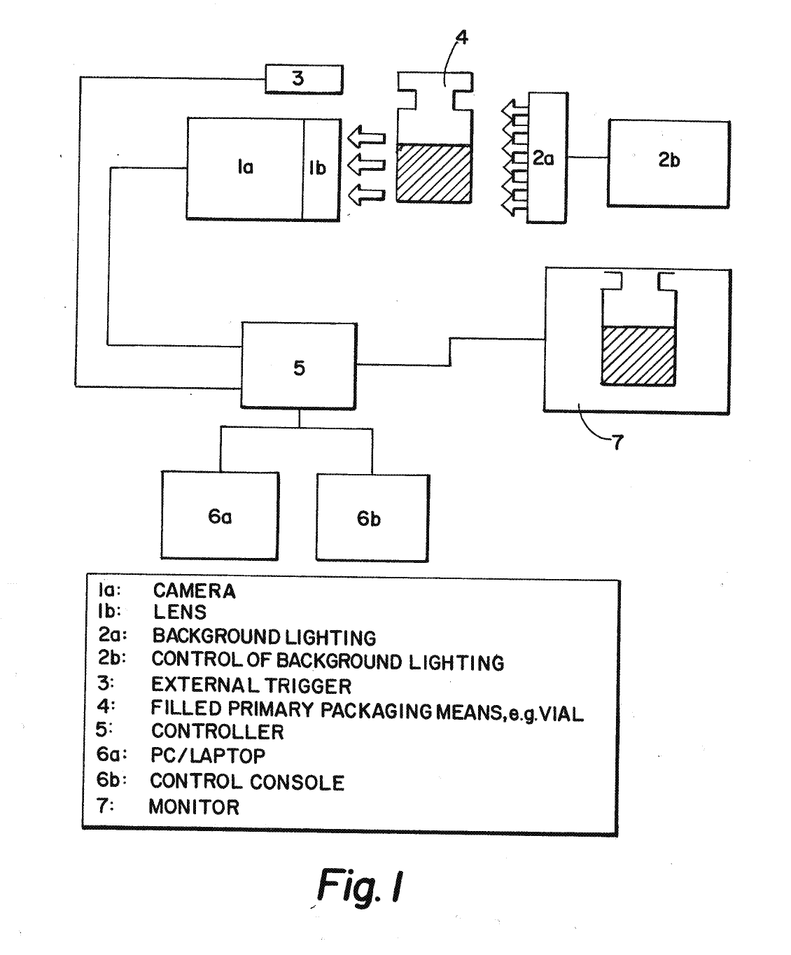

The term “primary packaging means” (cf. FIG. 1, component (4)) refers to a receptacle (vessel or container) that is in direct contact with the pharmaceutical composition. The primary packaging means has to be clear or transparent for the process according to the invention. It is filled with a protein solution and then the fill level is measured by the optical method according to the invention. The said primary packaging means (4) are preferably an injection bottle or a vial. The primary packaging means are preferably also a carpule, particularly a twin-chamber carpule, or a ready-to-use syringe.

“Vial” means an injection bottle or pierceable bottle.

“Carpule” or “twin-chamber carpule” means a cylindrical ampoule for liquid or lyophilised active substance solutions. In twin chamber carpules the lyophilisate is contained in the front part and the solvent in the rear part. The two chambers are separated from one another by a rubber stopper.

Carpules or twin-chamber carpules are generally used in a pen system or in a carpule syringe.

By “foaming” is meant the tendency of a liquid to foam as a result of the inclusion of gas. The degree of foaming during transfer into a primary packaging means is dependent on a number of factors, e.g. the formulation, the protein concentration, the speed of filling or the geometry of the filling needle.

The term “fill level” denotes the fill height of the solution in a primary packaging means, particularly a container/vial.

The term “fill volume” refers to the volume of solution transferred into the primary packaging means. Preferably it is a protein solution.

The term “satisfactory measurement” denotes that the fill volume of a container has been measured within a set tolerance, e.g. ±3% of the actual value.

The term “defective measurements” indicates those measured results where it is not possible to calculate the fill volume correctly. Possible causes of such defective measurements are the use of the wrong edges in the geometric measurement of the camera image or the fact that the reference edges needed have not been found by the programme at all. If the primary packaging means that are to be measured are in contact with other primary packaging means on one side, for example, the camera programme may not find a reference edge, or may find the wrong reference edge, for measuring the outer diameter.

The term “trigger” denotes an initiator or timer.

The term “controller” denotes the control equipment for the camera system.

The term “in-process fill level measurement” denotes the measurement of the fill level of a primary packaging means, particularly a container/vial, filled with solution, during the ongoing filling process and direct conversion of this fill level to a fill volume.

“Proteins” are macromolecules and are among the basic building blocks of all cells. Human proteins may be up to 3600 kDa in size.

The terms “peptide”, “polypeptide” or “protein” are polymers of amino acids consisting of more than two amino acid groups.

The terms “peptide”, “polypeptide” or “protein” also denote polymers of amino acids consisting of more than 10 amino acid groups.

The term “protein” used here refers in particular to polymers of amino acids with more than 20 and in particular more than 100 amino acid groups.

The term “active substances” refers to substances, particularly proteins in the present application, which evoke an effect or a reaction in an organism, e.g. antibodies. If an active substance is used for therapeutic purposes in humans or in animal bodies it is referred to as a pharmaceutical composition or medicament.

The abbreviation “MV” refers to a measured value.

The invention relates to a process for optically measuring fill level in the aseptic bottling or packaging of biopharmaceuticals, comprising the following steps:
a. transporting a transparent primary packaging means (4) filled with a protein solution, the fill volume being less than or equal to 100 ml,
b. moving the filled primary packaging means (4) past a camera (1a) with lighting,
c. controlling the image capture using an external trigger (3) that is linked to the camera (1a) via a controller (5),
d. delivering the measurement through the controller (5),
e. displaying it on a monitor (7) or on a linked PC (6a);
the primary packaging means (4) being separate and suspended at the time of the measurement.

In a preferred embodiment the process according to the invention is an in-process method.

In another preferred embodiment of the process according to the invention the fill volume is less than or equal to 50 ml, less than or equal to 25 ml, preferably less than or equal to 20 ml.

In another preferred embodiment of the process according to the invention the fill volume is in the range from 100 ml to 0.5 ml, preferably in the range from 25 ml to 2 ml or 20 ml to 1 ml or 20 ml to 0.5 ml or 10 ml to 0.5 ml and particularly preferably in the range from 2 ml to 0.5 ml.

In a specific embodiment of the process according to the invention the primary packaging means is:
a. an injection bottle, e.g. 2R, 10R, 20R, 50 ml or 100 ml,
b. a carpule, e.g. a twin-chamber carpule,
c. a ready-to-use syringe.

In a specific preferred embodiment of the process according to the invention the primary packaging means is a 20R or 2R injection bottle.

In another preferred embodiment the primary packaging means is a twin-chamber carpule.

In a special embodiment of the process according to the invention the lighting in step b) is background lighting (2a).

In a preferred embodiment of the process according to the invention the primary packaging means are suspended vertically.

The invention further relates to an apparatus for optically measuring fill level, consisting of a camera system (1a), a device (8) for separating the primary packaging means (4) and a device (9) for suspending the primary packaging means (4).

In a preferred embodiment the apparatus according to the invention includes a star wheel (8) for separating the primary packaging means (4).

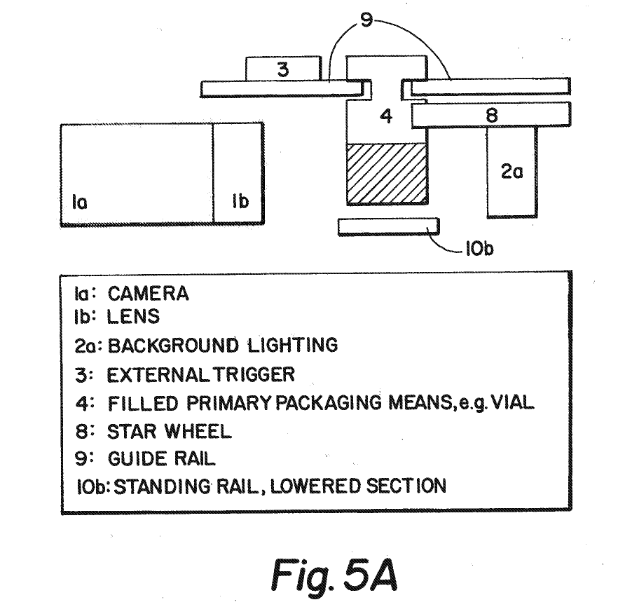

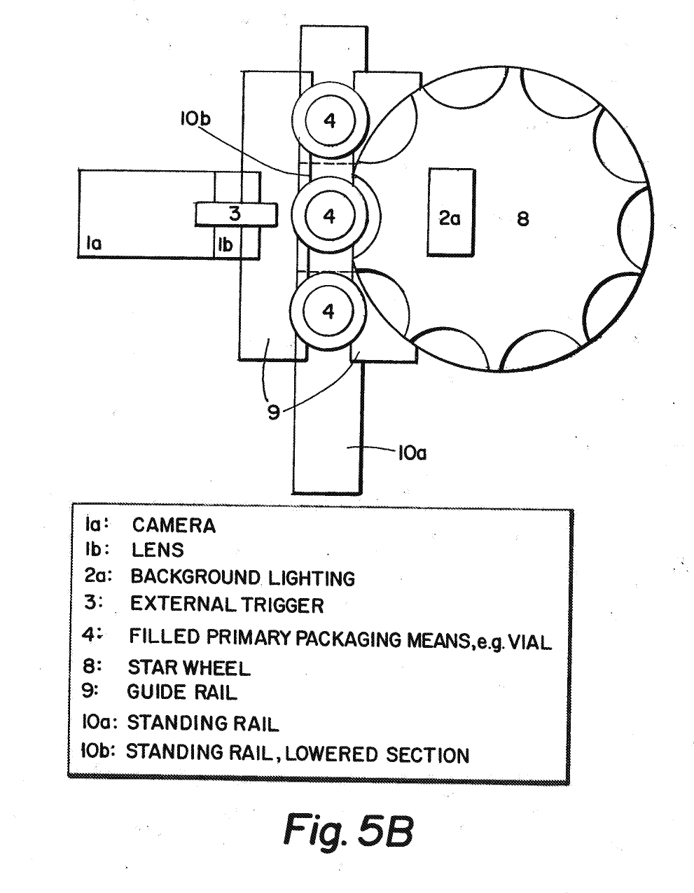

In a particularly preferred embodiment the apparatus according to the invention is an apparatus for optically measuring fill level according to FIG. 5B.

The Examples listed below are not to be construed in a limiting or restrictive capacity. They serve only to illustrate the invention.

### EXAMPLES

### Example 1

### Measuring Principle and Preliminary Tests

FIG. 1 shows the operating principle of the optical measurement of fill level using a camera system. The vial is moved past a camera by a transporting system (star wheel, conveyor belt . . . ). The object is generally illuminated by background lighting for optimum image recording. The image capture is controlled by an external trigger which detects each individual vial.

The camera and trigger are linked together by a controller which contains the software. The image and the measured results are delivered directly using a monitor which is also linked to the controller.

The controller is actuated by a control console or an external PC/laptop.

In order to test the basic feasibility of the optical monitoring of fill levels using a camera system, first of all the following preliminary tests were carried out:

Measurement of
20R vials at rest,
20R vials on a conveyor belt and
2R vials on a conveyor belt.

The vials used had been filled by hand with specified fill volumes.

In addition, the effects of foaming on the accuracy of the measurement of fill level were observed.

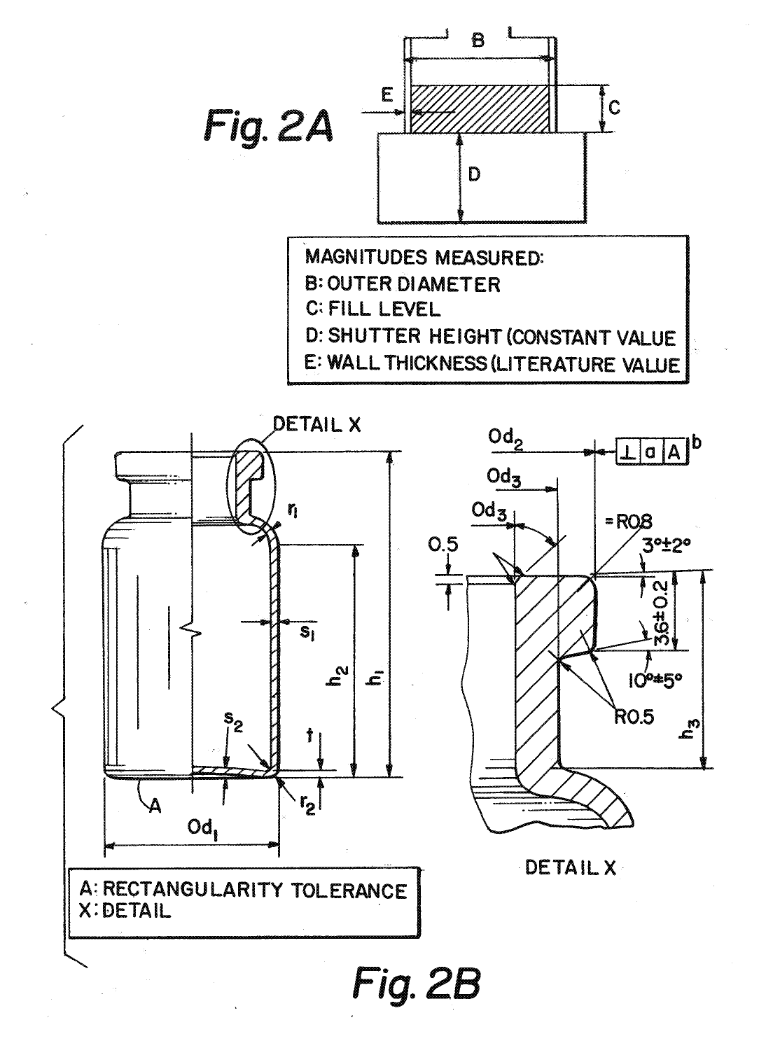

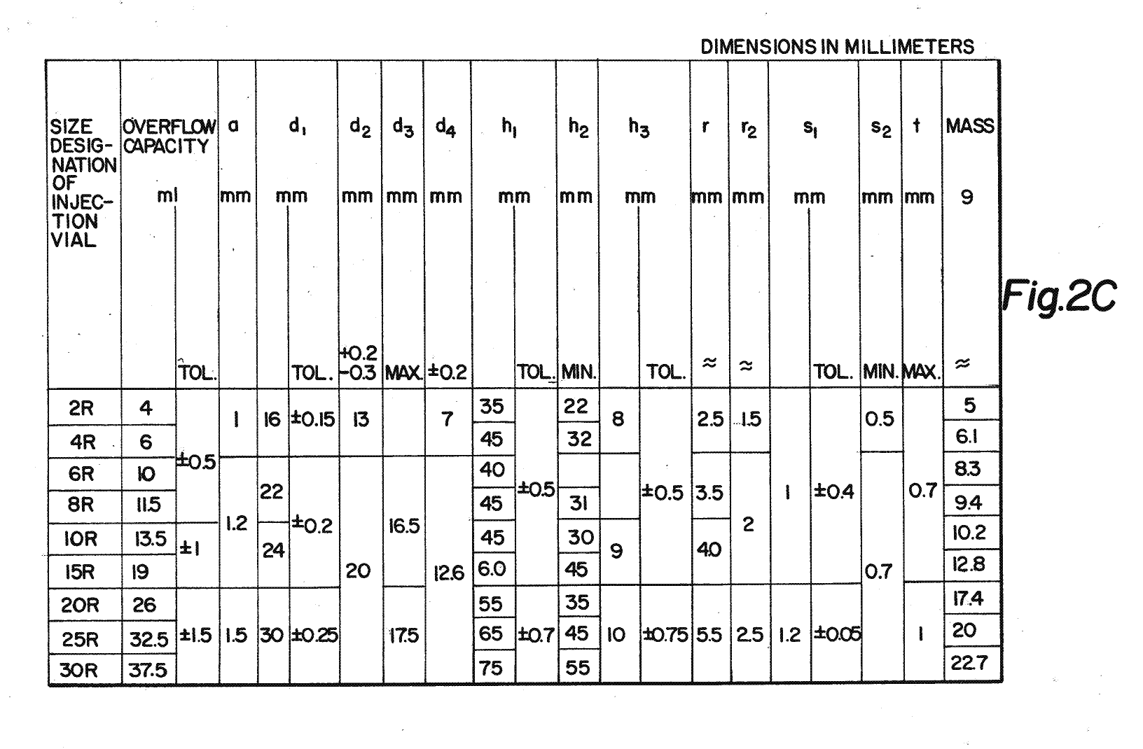

FIG. 2 shows the measuring arrangement during these preliminary tests.

The distance between the lower edge of the meniscus and the upper edge of a fixedly installed shutter located in front of the vial is measured at several points. The average of these measurements gives the “fill level” result.

The outer diameter of the vials is also measured, in order to detect any variations in the packaging.

The fill volume in ml is calculated from

[(fill level+shutter height−X)*π*(outer diameter−2*wall thickness s₁)²/4)]/1000

The wall thickness is assumed to accord with EN ISO 8362-1:2004 (cf. FIGS. 2B and C). For the convex base, because of the dimensions in EN ISO 8362-1:2004 (FIG. 2) and the associated base convexity and radii, a factor X is assumed which may vary depending on the size of the vial. The height of the shutter is a fixed value but may vary depending on the measuring arrangement.

### Measurement at Rest

The measurements obtained at rest with the 46 vials pre-filled with 15 ml to 21 ml water showed fluctuations between −0.1 ml to +0.2 ml based on the nominal fill volumes. This corresponds to an order of magnitude of approx. 1%.

### Measurement on a Conveyor Belt

### 20R:

Each of the 46 water-filled vials was measured over 3 runs, travelling non-stop on a conveyor belt.

The averages of the volumes measured show a mean deviation of not more than 0.2 ml. Of a total of 138 measurements obtained, 6 (=4.3%) show a deviation of more than ±0.5 ml, which is given as the tolerance for standard fillings with a fill volume of 20.8 ml.

In the case of fill volumes of >=21.0 ml in a 20R vial it was found that the meniscus already projects slightly into the shoulder region of the vial, so that its curvature varies. This change in geometry has to be taken into account when converting the fill level into the fill volume.

### 2R:

Each of the 50 vials filled with 1.0 ml water was measured 1× on the conveyor belt. All the measurements reliably showed a fill volume within a range from −0.02 ml to +0.01 ml based on the ACTUAL volume weighed in.

### Effects of Foaming

The effect of the foaming that frequently occurs when filling protein solutions was studied using a model protein solution. The fill volume of 7 vials was first determined at rest using the camera system. Then each vial was shaken by hand, left to stand for 30-60 sec until hardly any air bubbles were rising in the liquid, and then the fill volume was determined again using the camera system.

As a result of the foaming, the camera system detected a fill volume that was 0.1 ml to 0.3 ml lower than before the shaking. In spite of the foaming, the fill volumes measured were all situated within a tolerance of ±0.5 ml.

### Example 2

### Measurement of Fill Level in a Filling Machine

After the preliminary tests had demonstrated the basic feasibility of optically measuring fill level with a camera system, further tests were carried out with 20R vials and with 2R vials on two different filling machines.

### 20R Vials on INOVA No. 5:

The measuring arrangement was implemented in the filling machine as described in the preliminary tests/Example 1.

100 vials were filled with a desired fill volume of 20.0 ml of purified water at a rate of 3.5 SKT (approx. 1200 vials/h) and then stoppered.

On leaving the star wheel, the fill level of each vial was measured using the camera system.

Each individual vial was weighed before and after filling (without a stopper) in order to determine the precise fill volume.

The average of the 100 measurements is 19.81 ml. The standard deviation from the mean is 0.49 ml.

78% of the vials measured fall within the tolerance of ±0.5 ml deviation from the desired value which is prescribed for this fill volume.

It was noticeable that the outer diameter of 31 of the 100 vials measured was detected as being outside the manufacturing tolerance. This is probably due to one of the following causes:
Blurred camera shot as a result of insufficient distance between
   the background lighting and vial
inaccurate measurement of the outer diameter because
   the vials had not been separated and
   the measurement of the outer diameter is carried out only at a single point.

Moreover the meniscus varied considerably as a result of the expulsion of the vials from the star wheel, which occurred directly before the measurement.

The optimisation requirement established in this test was taken into consideration when measuring the 2R vials on the B&S No. 4 filling machine and the necessary mechanical provisions were made.

Optimisation by the following measures:
background lighting is moved back
separation is essential
base must be included in measurements.

### 2R Vials on B&S No. 4:

The outlet section of filling machine B&S No. 4 was fitted with a star wheel for separating the vials for the optical measurement of fill level.

The purpose of this separation was to allow unobstructed measurement of the outer diameter without any immediately adjacent vials. The outer diameter is measured not just at one point but at 5 points and the average is calculated.

In addition, the background lighting was set back to improve the sharpness of the image.

### Guiding the Vials on a Standing Rail:

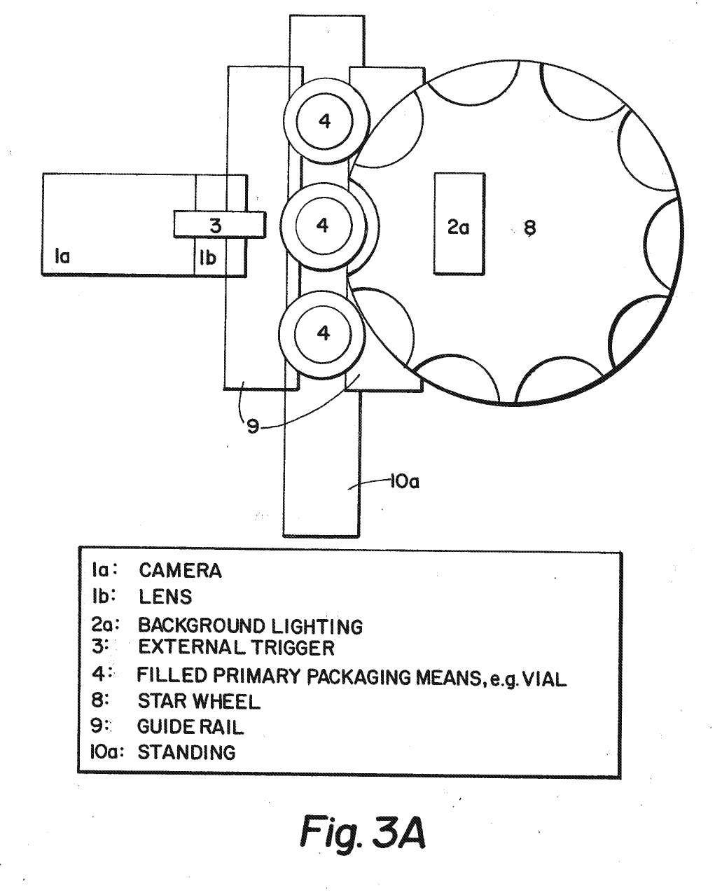

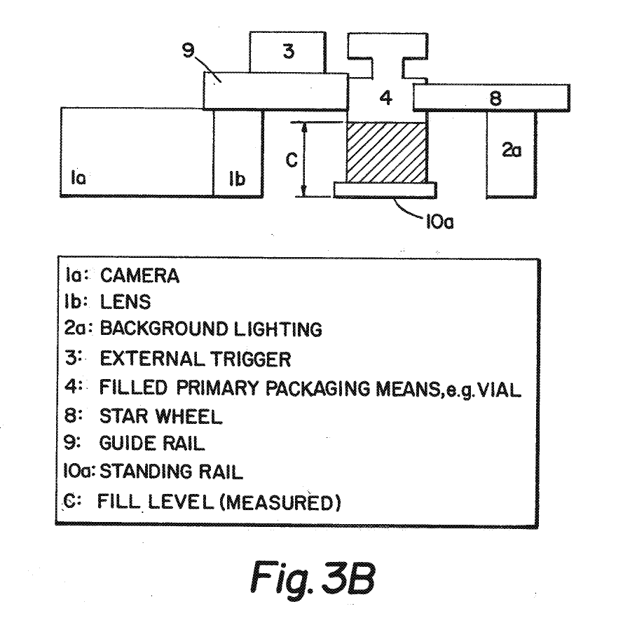

FIG. 3A shows the first adaptation of the outlet section including the star wheel for separation and the set-back background lighting. The star wheel has no drive but is passively rotated by the succession of new vials from the transporting star of the filling machine. The vials are guided here only by a guide rail in the upper region of the vial, so that the lower part can be well illuminated and thus measured. Instead of the shutter in FIG. 2A, the standing rail is used here as the reference point for measuring the fill level. As in the preliminary tests as well, the measurement of the fill level takes place not at one point but at several points on the meniscus, to equalise any fluctuations in the liquid.

This results in the following formula for calculating the fill volume in ml:

[(MV fill level−standing rail)*π*(MV outer diameter−2*wall thickness s₁)²/4)]/1000

The wall thickness according to EN ISO 8362-1:2004 is used as described in Example 1.

Within the scope of this test series different settings and configurations of the camera system and the programmed measuring programmes were used.

The vials were each filled with a desired fill volume of 1.0 ml of purified water using the B&S No. 4 filling machine and then stoppered.

The following section shows a summary of the tests carried out, the settings used and the statistical evaluation of the results.

(1) Tare-Gross Weighing of all Vials Before and after Filling and Exact Correlation of the Camera Measurements in the Filling Machine with the Actual Fill Volume

| filling rate: | 4 SKT [symbol] approx. 800 vials/h | |
|---|---|---|
| fill level measurement | 20 measured points each having 3 pxl | |
| trigger delay: | 850 | ms |
| lighting time: | 1/240 | ms |
| number of vials measured: | 100 | items |

Results:

| | | |
|---|---|---|
| Initial fill quantity check | | 1.01 ml |
| camera measurements | MV of the filled vials | 1.01 ml |
| camera measurements: | MV ± 0.03 ml | 93% |
| vials with fill volume . . . | <MV − 0.03 ml | 1% |
| | >MV + 0.03 ml | 6% |

(2) Increasing the Filling Rate while Keeping the Same Fill Quantity Setting of the Filling machine and the same camera settings as in (1); No Tare-Gross Weighing

| filling rate: | 8 SKT [symbol] approx. 2500 vials/h | |
|---|---|---|
| fill level measurement: | 20 measuring points each with 3 pxl | |
| trigger delay: | 850 | ms |
| lighting time: | 1/240 | ms |
| number of vials measured: | 114 | items |

results:

| | | |
|---|---|---|
| Initial fill quantity check | 1.01 | ml |
| camera measurement: | 1.01 | ml |
| MV of filled vials | | |

| | |
|---|---|
| camera measurements: | 72% |
| vials with fill volume | |
| 0.97-1.03 ml¹ | |

¹The filling tolerances specified in manufacturers' own instructions for such small volumes are +/− 0.03 ml of the desired fill volume, which is 1.00 in this case

### (3) Increasing the Accuracy of Measurement at a Filling Rate of 8SKT by Altering the Camera Settings; No Tare-Gross Weighing

| filling rate: | 8 SKT [symbol] approx. 2500 vials/h | |
|---|---|---|
| fill level measurement: | 14 measuring points each with 2 pxl | |
| trigger delay: | 1100 | ms |
| lighting time: | 1/120 | ms |
| number of vials measured: | 111 | items |

results:

| | | |
|---|---|---|
| Initial fill quantity check | 1.00 | ml |
| camera measurement: | 0.98 | ml |
| MV of filled vials | | |

| | |
|---|---|
| camera measurements: | 81% |
| vials with fill volume | |
| 0.97-1.03 ml¹ | |

### (4) Verification of the Amended Camera Settings for Lower Speeds; No Tare-Gross Weighing

| filling rate: | 4 SKT [symbol] approx. 800 vials/h | |
|---|---|---|
| fill level measurement: | 14 measuring points each with 2 pxl | |
| trigger delay: | 1100 | ms |
| lighting time: | 1/120 | ms |
| number of vials measured: | 107 | items |

results:

| | | |
|---|---|---|
| Initial fill quantity check | 1.00 | ml |
| camera measurement: | 0.99 | ml |
| MV of filled vials | | |

| | |
|---|---|
| camera measurements: | 81% |
| vials with fill volume | |
| 0.97-1.03 ml¹ | |

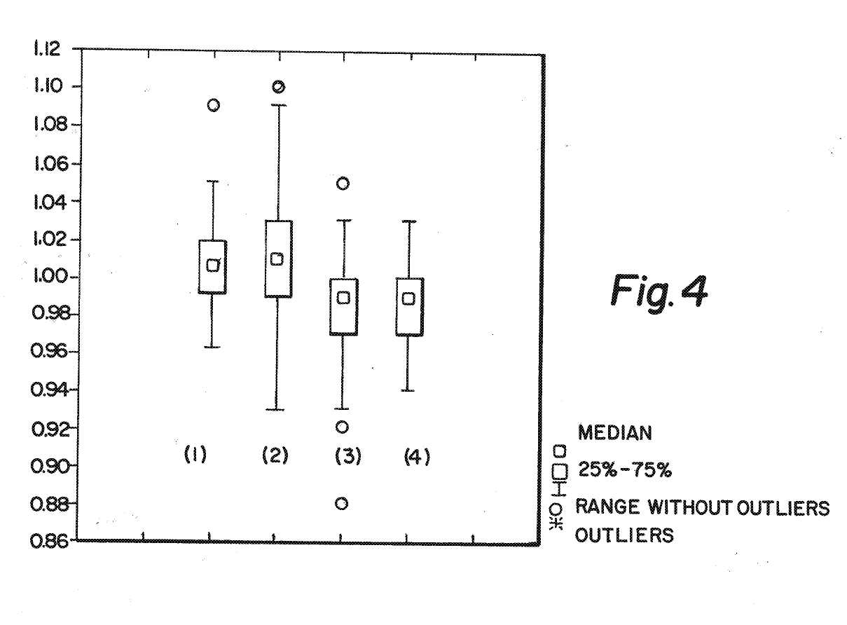

FIG. 4 shows the symmetry and the scattering of the results from tests (1) to (4) incl. the interquartile ranges and the spreads.

Increasing the filling rate in the second test led first of all to a distinct scattering of the measurements. The spread was virtually doubled by comparison with the first test.

By adjusting the camera settings and slightly modifying the measuring programme it was possible to reduce the scattering of the measured values in tests (3) and (4) still further for both the fast and slow filling rate.

The slight downward shift in all the measuring points in tests (3) and (4) is due partly to the actual fill quantity selected being 0.01 ml lower than in the previous tests, and also to the altered settings.

The inaccuracies of measurement or deviations from the real ACTUAL fill volume that have occurred up till now presumably have two causes:
slight lifting of the vials by the transportation using the star wheel on the standing rail. As the measurement of the fill level is based on the lower edge of the standing rail, the measurement of fill level is falsified in vials that are slightly raised above the standing rail at the time of measurement.
variations in the thickness of the bases of the vials between different batches of vials.

In order to implement this optimisation requirement, further adjustments were carried out in the region of the star wheel and tested in several tests (cf. the following test arrangement).

Suspension of the Vials by their Neck Region

The vials are guided after modification by two rails by means of their neck region, the vials being suspended by their rolled edge (cf. FIGS. 5A+B).

The standing rail is lowered downwards in the region of the camera shot (between the dotted lines in FIG. 5B), to enable a clear delineation of the base of the vial.

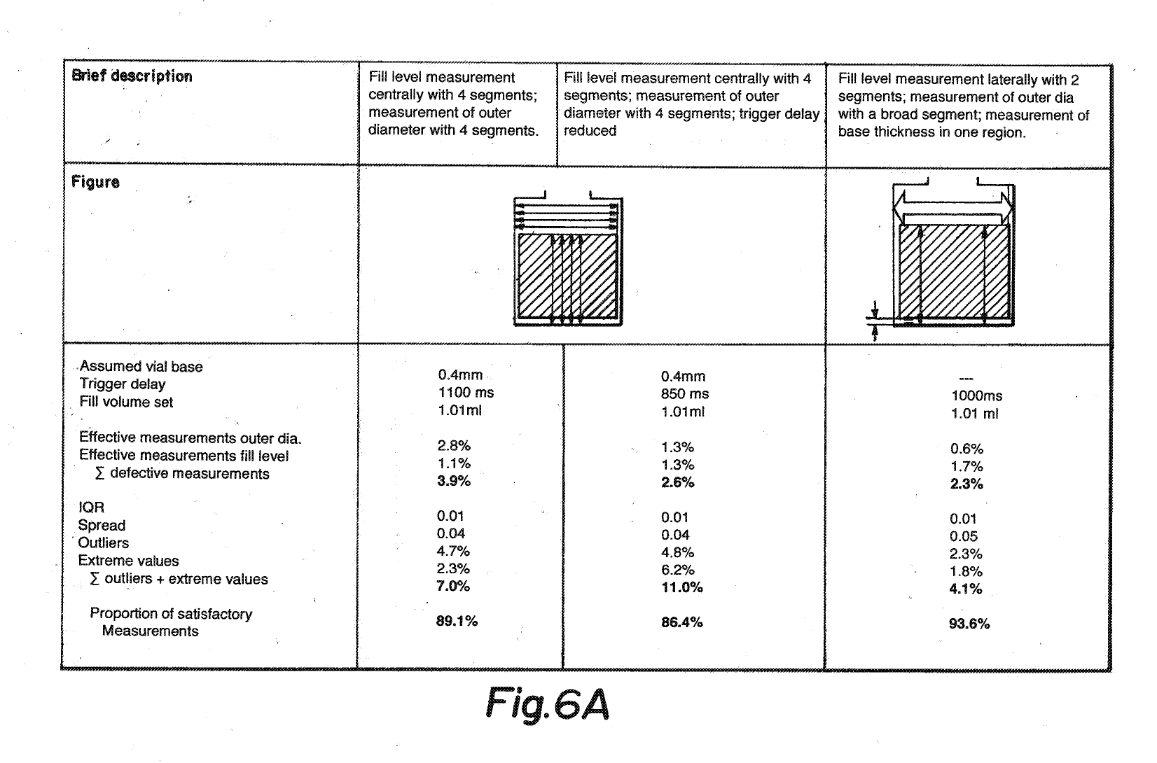

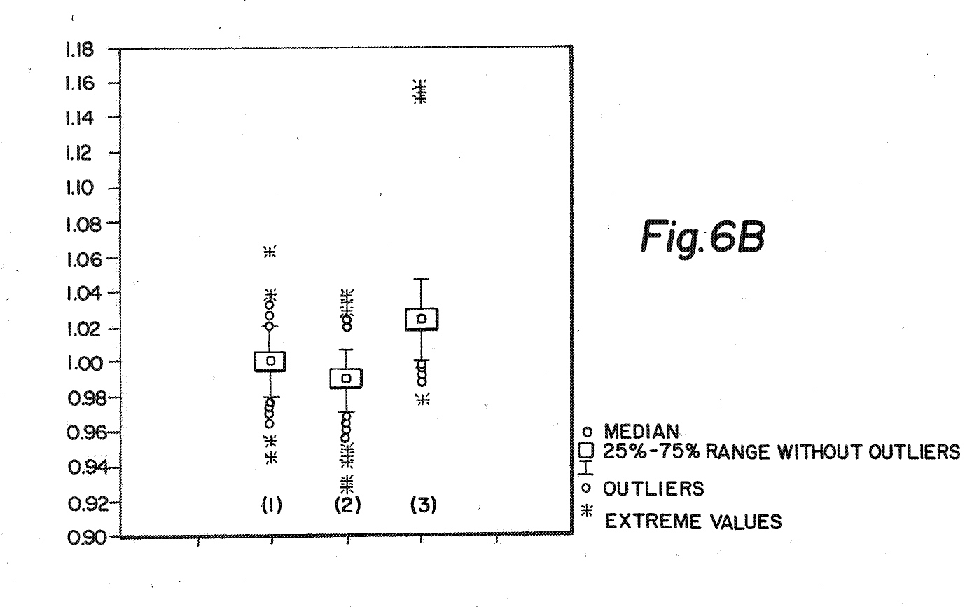

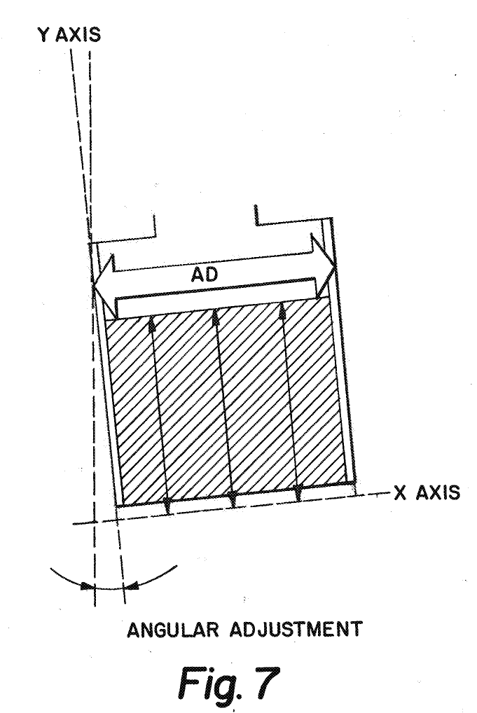

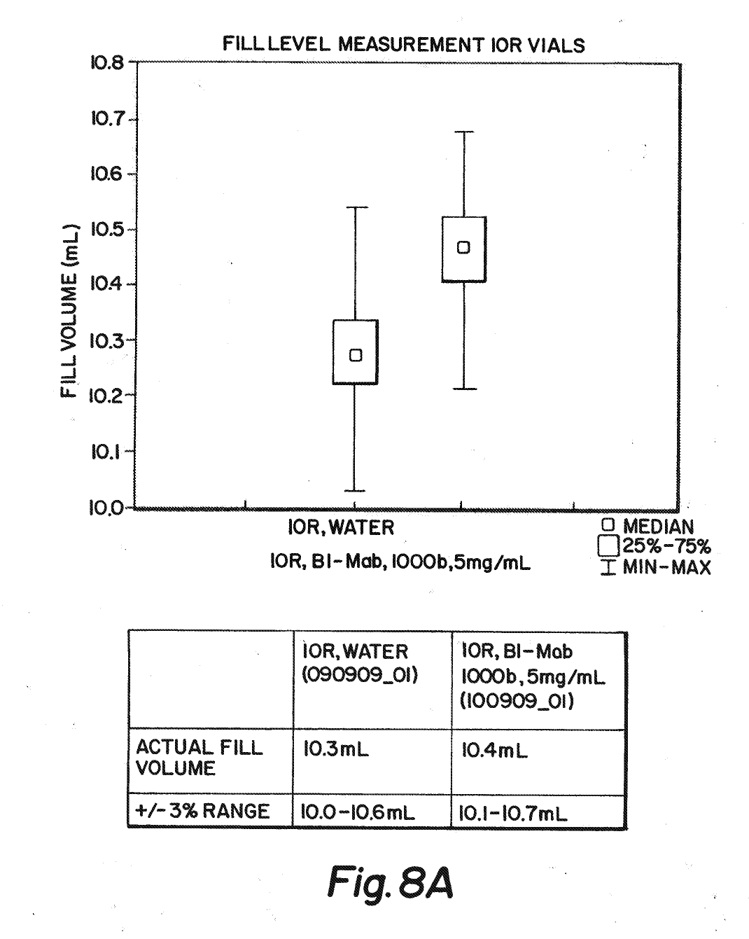

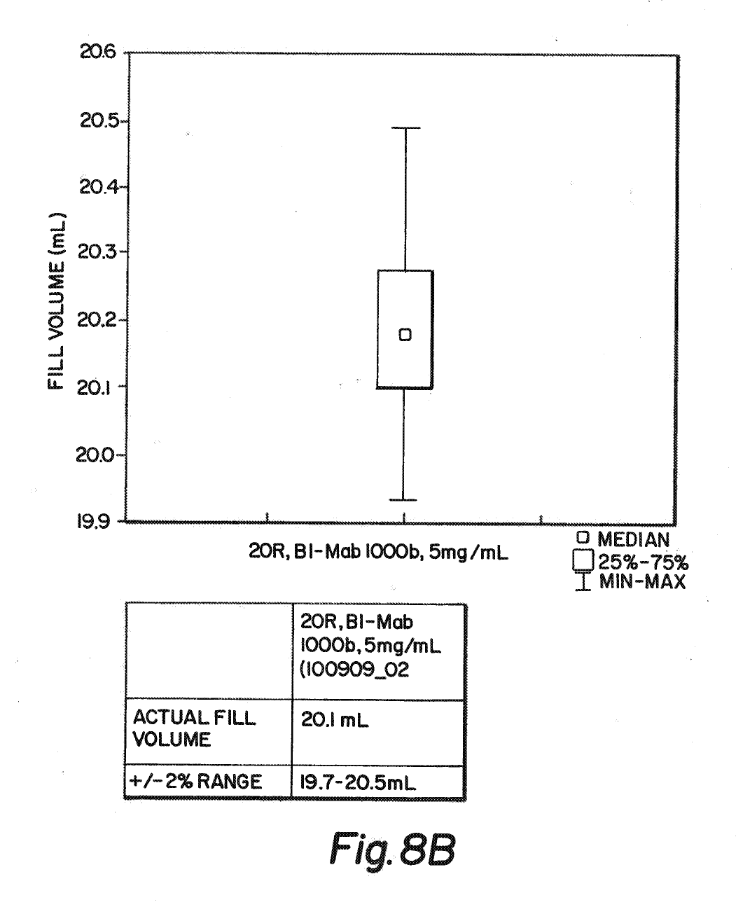

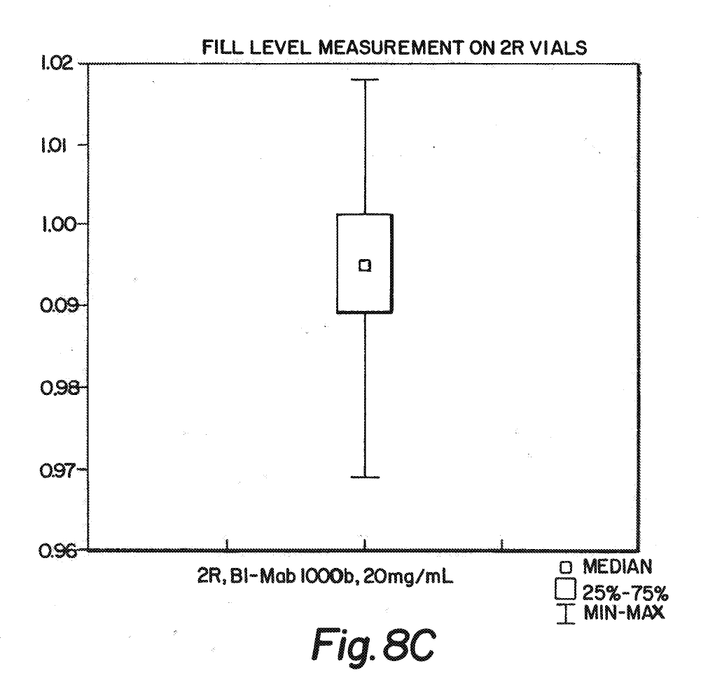

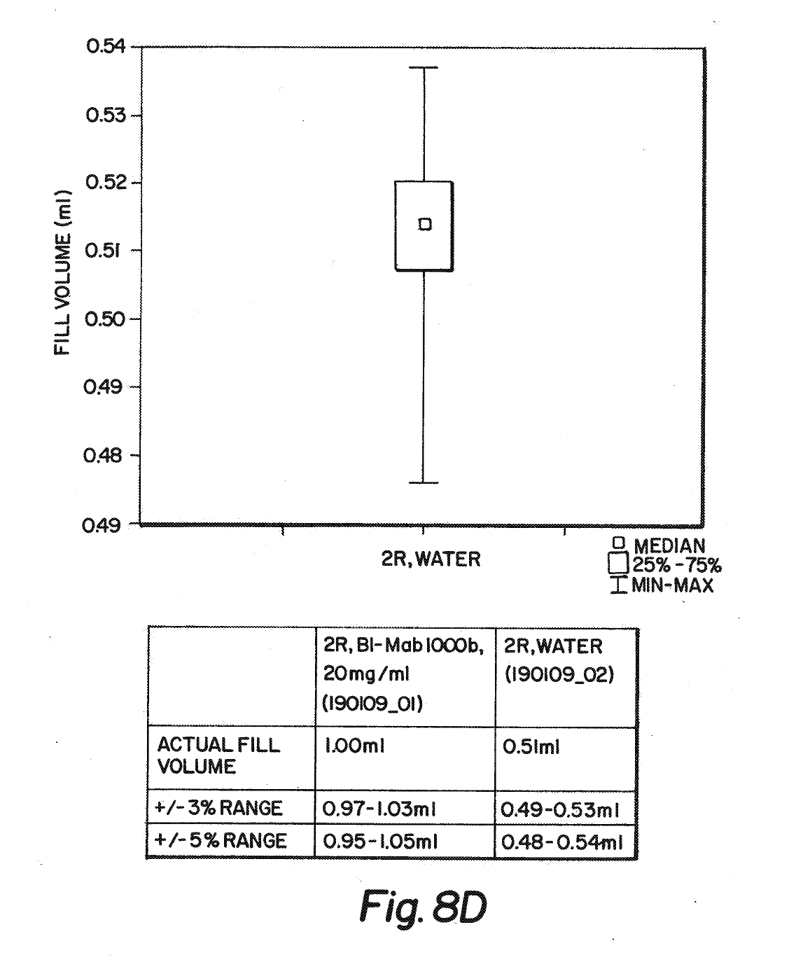

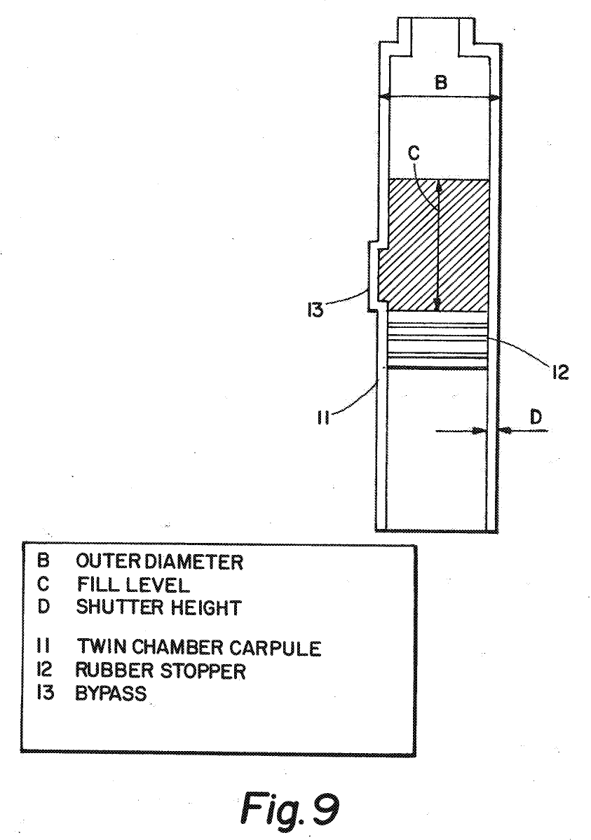

Using this mechanical arrangement, the test series shown in FIG. 6A were carried out. The following parameters apply to all the tests:

| | |
|---|---|
| filling rate: | 8 SKT (2500 vials/h) |
| fill volume selected: | 1.01 ml |
| pre-treatment of the vials: | rinsed, sterilised with hot air |
| lighting time: | 1/240 ms |

In previous tests it was established that the geometric shape of the meniscus is more uniform in new untreated vials than in vials that have been rinsed and sterilised with hot air before use.

This can be put down to the surface roughness of the treated glass surface.

To create conditions similar to those encountered in production, only vials that have been rinsed and sterilised with hot air were used for the test series described here.

The vials were each filled with a desired fill volume of 1.0 ml of purified water using the B&S No. 4 filling machine and then stoppered.

The fill volumes were calculated in ml for the first two test series according to

[(MV fill level−assumed vial base)*π*(MV outer diameter−2*wall thickness s₁)²/4)]/1000

As the vial base was also measured at one point in the third test series, the following formula was obtained for calculation of the fill volume in ml in this case:

[(MV fill level−base thickness*0.9)*π*(MV outer diameter−2*wall thickness s₁)²/4)]/1000

The factor 0.9 is an empirically determined value which takes account of the base convexity of the 2R vial.

The wall thickness used in both formulae is in accordance with EN ISO 8362-1:2004 as described in FIG. 2A (cf. also Example 1—calculation of fill volume).

The test series were assessed according to the following criteria:
percentage of defective measurements at the outer diameter
percentage of defective measurements at the fill level
interquartile range
spread
percentage of outliers
percentage of extreme values
   and compared with one another.

FIG. 6B shows the representation of the test results of the three test series described as a box plot. The defective measurements of the outer diameter and fill level were not taken into consideration in this evaluation.

It is clear that the measurements obtained in the three test series have a highly symmetrical distribution.

As shown also by the values of the spreads in FIG. 6A, the desired accuracy of ±0.03 ml is achieved, apart from a few outliers and extreme values.

The slight upward or downward shift to the desired value that occurs in all the test series does not influence the assessment of the measurement series as it could be eliminated by a correction factor.

In all, the third test series showed the smallest proportion of defective measurements and outliers and extreme values.

A further reduction in the defective measurements when measuring the outer diameter could be achieved by optimising the mechanical guiding of the vials. It would be prevented by the adjacent vials possibly touching the vial that is to be measured at the moment of measurement.

This aspect is taken into consideration for modifying other filling machines.

A reduction in the defective measurements of the fill level and an increase in the accuracy of measurement so that the proportion of measurements falling outside the tolerance of ±0.03 ml is reduced still further could be achieved by the following technical measures:
using a B/W camera (previously a colour camera)
using a lens that allows a larger photograph of the measured object to be taken
optimising the background lighting for better contrast.

### Example 3

### Measurement of Fill Level in Filling Machines with Optimised Mechanical Features and Optimised Settings

On the basis of the tests described under “EXAMPLE 2” mechanical adaptations were made to the filling machines and technical improvements were also made to the camera and programmes.

For sizes 2R, 10R and 20R the size components for separating the vials and the holders for the camera and background lighting were improved.

The height of the camera, the distance of the measured object and the appropriate lens for each of the three sizes of vial were selected to be the best possible and adjusted accordingly.

The camera programmes of the three sizes of vial were optimised to increase the precision and constructed analogously to one another (see FIG. 7).

The most important adaptations are:
Measurement of the outer diameter only to scale pixels to millimetres. The published value is used to calculate the fill volume.
No direct measurement of the base thickness. The fill volume is calculated using a constant that is determined empirically for each size of vial.
Measurement of the fill level from the meniscus to the base of the vial at 2 to 5 points and formation of an average
Adjustment of the measuring window in the x- and y-directions
Angular compensation along the y-axis in the case of diagonally suspended vials

This gives the following formula for calculating the actual fill volume:

[(MV fill level−base thickness)*π*(outer diameter d₁−2*wall thickness s₁)²/4)]/1000

The base thickness is the afore-mentioned empirically determined constant.

The published values according to FIG. 2C are used for the outer diameter d₁ and the wall thickness

With these optimised settings the following series of tests were carried out inter alia

| Test | Size | | Adjusted fill | | Number of |
|---|---|---|---|---|---|
| No. | of vial | Medium | volume | Filling rate | vials (=n) |
| 190109_02 | 2R | water | 0.51 ml | approx. 2500 vials/h | 224 |
| 190109_01 | 2R | BI-Mab 1000b | 1.00 ml | approx. 2500 vials/h | 365 |
| | | 20 mg/ml | | | |
| 090909_01 | 10R | water | 10.3 ml | approx. 1400 vials/h | 354 |
| 100909_01 | 10R | BI-Mab 1000b | 10.4 ml | approx. 1400 vials/h | 345 |
| | | 5 mg/ml | | | |
| 100909_02 | 20R | BI-Mab 1000b | 20.1 ml | approx. 1400 vials/h | 404 |
| | | 5 mg/ml | | | |

BI-Mab 1000b is a protein solution which is known to foam when decanted. The protein solution is used in the concentrations 5 mg/ml and 20 mg/ml.

The test series showed the following results:

| | Adjusted | Distribution of the measured values based | | |
|---|---|---|---|---|
| Test | fill | on the selected fill volume within . . . | | |
| No. | volume | ±5% | ±3% | ±2% |
| 190109_02 | 0.51 ml | 99.6% | 94.2% | n/a |
| 190109_01 | 1.00 ml | 100% | 99.7% | 95.9% |
| 090909_01 | 10.3 ml | 100% | 100% | 96.9% |
| 100909_01 | 10.4 ml | 100% | 100% | 95.1% |
| 100909_02 | 20.1 ml | 100% | 100% | 100% |

The greater the fill volume, the smaller the percentage deviations of the measured values from the actual fill volume.

The measured values of the test series carried out with protein solution showed comparable results to the test series carried out with water. FIGS. 8A to 8C show a graphic representation of the measurements obtained with the test series.

1. A process for optically measuring fill level during the aseptic bottling or packaging of biopharmaceuticals, comprising the steps of:
a. transporting a transparent primary packaging means (4) filled with a protein solution, the fill volume being less than or equal to 100 ml,
b. moving the filled primary packaging means (4) past a camera (1a) with lighting,
c. controlling the image capture using an external trigger (3) that is linked to the camera (1a) via a controller (5),
d. delivering the measurement through the controller (5),
e. displaying it on a monitor (7) or on a linked PC (6a);
the primary packaging means (4) being separate and suspended at the time of measurement.

2. The process according to claim 1, wherein said process is an in-process method.

3. The process according to claim 1, wherein the fill volume is less than or equal to 50 ml.

4. The process according to claim 1, wherein the fill volume is less than or equal to 25 ml.

5. The process according to claim 1, wherein the fill volume is less than or equal to 20 ml.

6. The process according to claim 1, wherein the fill volume is in the range of 100 ml to 0.5 ml.

7. The process according to claim 1, wherein the fill volume is in the range of 25 ml to 2 ml.

8. The process according to claim 1, wherein the fill volume is in the range of 20 ml to 1 ml.

9. The process according to claim 1, wherein the fill volume is in the range of 2 ml to 0.5 ml.

10. The process according to claim 1, wherein the primary packaging means is:
a. an injection bottle,
b. a carpule, or
c. a ready-to-use syringe.

11. The process according to claim 10, wherein the primary packaging means is a 20R, a 10R, a 2R, a 50 ml or a 100 ml injection bottle.

12. The process according to claim 10, wherein the primary packaging means is a 20R, a 10R or a 2R injection bottle.

13. The process according to claim 10, wherein the primary packaging means is a twin-chamber carpule.

14. The process according to claim 1, wherein the lighting in step b) is background lighting (2a).

15. The process according to claim 1, wherein the primary packaging means hangs vertically.

16. An apparatus for the optical measurement of fill level consisting of a camera system (1a), a device (8) for separating the primary packaging means (4) and a device (9) for suspending the primary packaging means (4).

17. The apparatus according to claim 16, said apparatus comprising a star wheel (8) for separating the primary packaging means (4).

18. The apparatus according to claim 16, said apparatus comprising guide rails (9), a standing rail (10a) and a lowered rail section (10b) for suspending the primary packaging means (4).

19. The apparatus according to claim 16, said apparatus comprising guide rails (9), a standing rail (10a) and a lowered rail section (10b) for suspending the primary packaging means (4).

20. An apparatus for optical measurement of fill level according to FIG. 5B.
